(19) United States
(12) Patent Application Publication
(10) Pub. No.: US 2013/0299561 A1
(43) Pub. Date: Nov. 14, 2013

(54) FRICTION STIR JOINING OF CURVED SURFACES

(71) Applicants: Paul T. Higgins, Houston, TX (US); Jeremy Peterson, Cedar Hills, UT (US); Rodney Dale Fleck, Mansfield, TX (US); Russell J. Steel, Salem, UT (US); Scott M. Packer, Alpine, UT (US); Murray Mahoney, Midway, UT (US); Rod W. Shampine, Houston, TX (US)

(72) Inventors: Paul T. Higgins, Houston, TX (US); Jeremy Peterson, Cedar Hills, UT (US); Rodney Dale Fleck, Mansfield, TX (US); Russell J. Steel, Salem, UT (US); Scott M. Packer, Alpine, UT (US); Murray Mahoney, Midway, UT (US); Rod W. Shampine, Houston, TX (US)

(21) Appl. No.: 13/894,226

(22) Filed: May 14, 2013

Related U.S. Application Data
(60) Provisional application No. 61/646,880, filed on May 14, 2012.

(51) Int. Cl. B23K 20/12; B23K 20/24

(52) U.S. Cl. CPC B23K 20/129; B23K 20/1275; B23K 20/128; B23K 20/24
USPC 228/114; 228/250; 228/256; 228/205; 29/557; 29/428

(57) ABSTRACT

A system and method for joining curved surfaces such as pipes by obtaining pipes having additional rough stock material on the pipe ends, the rough stock material being precision machine processed to prepare complementary face profiles on each of the curved surfaces and then performing friction stir joining of the pipes to obtain a joint that has fewer defects than joints created from conventional welding.

### BACKGROUND

Friction stir joining is a technology that has been developed for welding metals and metal alloys. Friction stir welding is generally a solid state process that has been researched, developed and commercialized over the past 20 years. Solid state processing is defined herein as a temporary transformation into a plasticized state that may not include a liquid phase. However, it is noted that some embodiments allow one or more elements or materials to pass through a liquid phase, and still obtain the benefits of the present.

Friction stir joining began with the joining of aluminum materials because friction stir joining tools may be made from tool steel which may adequately tolerate the loads and temperatures desired to join aluminum. Friction stir joining has continued to progress into higher melting temperature materials such as steels, nickel base alloys and other specialty materials because of the development of superabrasive tool materials and tool designs that may withstand the forces and temperatures that may be used to flow these higher melting temperature materials.

Even though there are several publications including patents that may describe the process of friction stir joining, there are several elements of the process that may be improved for friction stir joining to become a large-scale production process rather than a small-scale research project.

The friction stir joining process often involves engaging the material of two adjoining planar workpieces on either side of a joint by a rotating stir pin. Force is exerted to urge the pin and the workpieces together and frictional heating caused by the interaction between the pin, shoulder and the workpieces results in plasticization of the material on either side of the joint. The pin and shoulder combination or “FSW tip” is traversed along the joint, plasticizing material as it advances, and the plasticized material left in the wake of the advancing FSW tip cools to form a weld. The FSW tip may also be a tool without a pin so that the shoulder is processing another material through FSP.

FIG. 1 is a perspective view of a tool being used for friction stir joining that is characterized by a generally cylindrical tool 10 having a shank 8, a shoulder 12 and a pin 14 extending outward from the shoulder. The pin 14 is rotated against a workpiece 16 until sufficient heat is generated, at which point the pin of the tool is plunged into the plasticized planar workpiece material. The pin 14 is plunged into the planar workpiece 16 until reaching the shoulder 12 which prevents further penetration into the workpiece. The planar workpiece 16 is often two sheets or plates of material that are butted together at a joint line 18. In this example, the pin 14 is plunged into the planar workpiece 16 at the joint line 18.

Referring to FIG. 1, the frictional heat caused by rotational motion of the pin 14 against the planar workpiece material 16 causes the workpiece material to soften without reaching a melting point. The tool 10 is moved transversely along the joint line 18, thereby creating a weld as the plasticized material flows around the pin from a leading edge to a trailing edge along a tool path 20. The result is a solid phase bond at the joint line 18 along the tool path 20 that may be generally indistinguishable from the workpiece material 16, in contrast to the welds produced when using conventional non-FSW welding technologies.

It is observed that when the shoulder 12 contacts the surface of the planar workpieces, its rotation creates additional frictional heat that plasticizes a larger cylindrical column of material around the inserted pin 14. The shoulder 12 provides a forging force that contains the upward metal flow caused by the tool pin 14.

During friction stir joining, the area to be joined and the tool are moved relative to each other such that the tool traverses a desired length of the weld joint at a tool/workpiece interface. The rotating friction stir welding tool 10 provides a continual hot working action, plasticizing metal within a narrow zone as it moves transversely along the base metal, while transporting metal from the leading edge of the pin 14 to its trailing edge. As the weld zone cools, there is desirably no solidification as no liquid is created as the tool 10 passes suitably resulting weld is a defect-free, re-crystallized, fine grain microstructure formed in the area of the weld.

In the present state of the art, arcuate or curved surfaces such as pipes or tubes are joined together by butting the ends of the tubing together, inserting a support mandrel from an open end of the tubing under the joint, and then performing friction stir joining of the tubing. This concept has already been disclosed in patents and publications and is widely accepted as an effective means of joining curved surfaces together.

The terms “tubular”, “coiled tubing”, “tube”, “tubing”, “drillpipe”, “casing”, and “pipe” and other like terms for a curved surface may be used interchangeably. The terms may be used in combination with “joint”, “segment”, “section”, “string” and other like terms referencing a length of tubular.

Pipelines, tubulars and the like are widely used in many industries throughout the world and in many applications. Construction and manufacturing methods may be regulated by governments and industry standards organizations. Such oversight is considered desirable because any failure may be a risk for loss of life and limb. There have been several cases, for example, where numerous persons have been killed by natural gas line explosions that were caused by a faulty fusion weld. Decades of analyzing and documenting field failures have been the foundation of code cases currently followed for new construction of pipelines and other structures.

Even though friction stir joining is a newer joining technology, the process may still meet existing applicable government and industry standards as well as have new code cases written and approved for friction stir joining specific defects. While the concept of friction stir joining is relatively simple, there appears to be a lack of information in patents and literature that provides information for performing friction stir joining as a manufacturing process for curved surfaces that is free from defects.

For example, one of the defects found in friction stir joining is the root defect. A root defect may result when the material being stirred adjacent or nearly adjacent to a support mandrel experiences little or no flow from stirring.

FIG. 2 illustrates a cross section of two pipes 30 being joined together at a pipe joint 32 and a friction stir joining tool 34 performing the joining. A mandrel 36 provides support along the pipe joint 32. This figure shows that a friction stir joining root defect 38 is caused by a lack of penetration of the friction stir joining tool 34 into the pipe 30. The tip of the tool 34 is shown at what is likely an exaggerated distance from the mandrel 36 in order to illustrate the cause of the root defect 38.

The material being stirred at the pipe joint 32 by the friction stir joining tool 34 may need to flow completely from the bottom to the top of the pipe joint in order to create a solid state bond between the pipes 30. As shown, this defect is often the result of a lack of tool penetration and/or an oxide layer on the surfaces of the pipes 30 at the pipe joint 32 that has not been broken and consumed by the friction stir joining tool 34. Even careful microstructure evaluation of the pipe joint 32 after friction stir joining may not reveal the presence of the root defect 38. In most cases, the root defect 38 may be found by performing a bend test that opens the underside of the pipe joint 32 using stress and plastic strain.

The lack of friction stir joining tool penetration may often be a result of varying pipe wall thickness, or an “oval” shape of the pipe. The wall thickness variation may be common for the pipe manufacturing process and may occur from pipe section to pipe section as well as mill run to mill run. Pipe manufacturers dramatically raise the price of their products if tighter material and geometric tolerance specifications are requested because of the difficulties in ensuring consistent quality pipe manufacturing.

Furthermore, there is a belief in the industry that any variation in pipe dimensions may be compensated for with the fusion welding process because overmatched filler metal is used to join the pipes together. This is because conventional welding processes have the ability to compensate for broad geometric variances in pipe joints. However, compensation comes at the expense of consistency due to the broad range of solidification defects, residual stresses and cross section hardness variation at the fusion welding joint. Friction stir joining will have the same degree of variation in joint quality between pipes if new and innovative approaches are not implemented to take advantage of the benefits offered by a solid state joining process.

### SUMMARY

A system and method for joining curved surfaces such as pipes by obtaining pipes having additional rough stock material on the pipe ends, the rough stock material being precision machine processed to prepare complementary face profiles on each of the curved surfaces and then performing friction stir joining of the pipes to obtain a joint that has fewer defects than joints created from conventional welding.

These and other objects, features, advantages and alternative aspects of the present will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an illustration of the prior at showing friction stir welding of planar workpieces.

FIG. 2 is an illustration of the prior art showing a perspective view of a root defect being caused by lack of penetration of a friction stir joining tool along a pipe joint.

FIG. 3 is a perspective view of a pipe with an end having additional rough stock material that may be precision machine processed to create a face profile.

FIGS. 4A and 4B are cut-away side and perspective views of pipe ends prepared for friction stir joining, including a standard butt joint and a mandrel underneath the joint.

FIGS. 5A and 5B show cut-away side and perspective views of a first embodiment showing complementary face profiles on pipe ends, where the pipes are precision machine processed to provide a thread or groove profile.

FIGS. 6A and 6B show cut-away side and perspective views of an alternative embodiment showing complementary face profiles on pipe ends, where the pipes are precision machine processed to provide a chamfer taper or bevel at the root or ID of the pipes.

FIGS. 7A and 7B show cut-away side and perspective views of an alternative embodiment showing complementary face profiles on pipe ends, where the pipes are precision machine processed to provide a chamfer taper or bevel at the root of the pipes and at the OD corner of the pipes.

FIGS. 8A and 8B show cut-away side and perspective views of an alternative embodiment showing complementary face profiles on pipe ends, where the pipes are precision machine processed to provide a curved profile.

FIGS. 9A and 9B show cut-away side and perspective views of an alternative embodiment showing face profiles on pipe ends, where the pipes are precision machine processed to provide a profile that combines different profiles on each of the pipe ends.

FIGS. 10A and 10B show cut-away side and perspective views of an alternative embodiment showing complementary face profiles on pipe ends, where the pipes are precision machine processed to provide a partial thread, groove or other profile.

FIGS. 11A and 11B show cut-away side and perspective views of an alternative embodiment showing complementary face profiles on pipe ends, where the pipes are precision machine processed to provide a single or multiple different profiles.

FIGS. 12A and 12B show cut-away side and perspective views of an alternative embodiment showing face profiles on pipe ends, where the pipes are precision machine processed to provide a single or multiple different profiles.

FIGS. 13A and 13B show cut-away side and perspective views of an alternative embodiment illustrating that the mandrel is machined to include a profile that will alter flow of the pipe material.

FIGS. 14A and 14B show cut-away side and perspective views of an alternative embodiment showing face profiles and possibly the mandrel are precision machine processed in order to allow a second material to be joined to the pipes during friction stir joining.

FIG. 15 is a cut-away perspective view of an alternative embodiment that shows a second material disposed between the pipe ends, the second material standing proud relative to the pipes.

FIG. 16A is a cut-away perspective view of a filler material that may be substituted for the filler material of FIG. 15.

FIG. 16B is a cut-away perspective view of an alternative embodiment of the filler material of FIG. 16A.

FIG. 16C is a cut-away perspective view of an alternative embodiment of the filler material of FIG. 16A.

FIG. 17 is a perspective view of a stationary shoulder tool configuration.

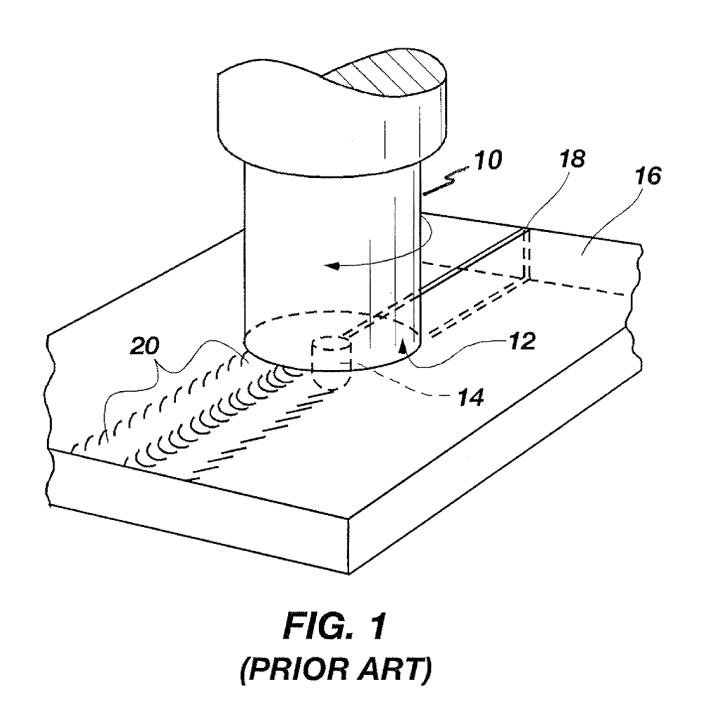

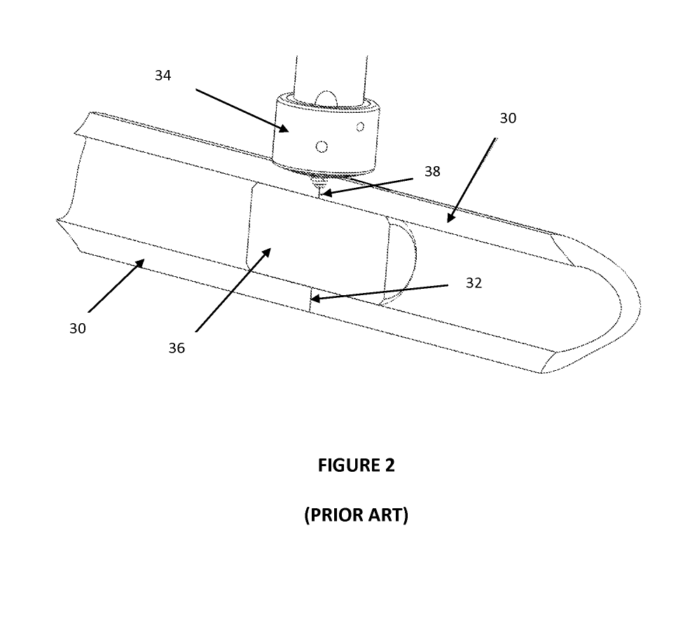

### DETAILED DESCRIPTION

Reference will now be made to the drawings in which the various embodiments will be given numerical designations and in which the embodiments will be discussed so as to enable one skilled in the art to make and use the embodiments of the invention. It is to be understood that the following description illustrates embodiments of the present invention, and should not be viewed as narrowing the claims which follow.

The first embodiment begins with the preparation of the pipes to be joined. In order to achieve the desired consistency, a precision machining process for preparing the ends of the pipes to be joined may be introduced as a prelude to friction stir joining. The precision machine processing may be unlike a conventional welding process that does not use precision machine processing to prepare the pipe ends for welding. Therefore, it is desired that all pipes to be joined may first be precision machine processed in order to have a higher degree of geometric precision, as compared to pipes that are conventionally welded, that is a precision machining process performed prior to joining.

Accordingly, the pipes may need to have sufficient extra material or rough stock material on the portion of the pipes where they are to form a joint. The rough stock material may then be removed in a pre-joining precision machining process in order to achieve the desired geometric specifications of pipes that are ready to be joined using friction stir joining. The desired level of ovality, concentricity, wall thickness and diameter specifications for the pre-joined pipes may be known and compared to the capabilities of the pipe manufacturing process. The rough stock that is desirable in order to consistently maintain these final specifications may be supplied with the pipe from the mill.

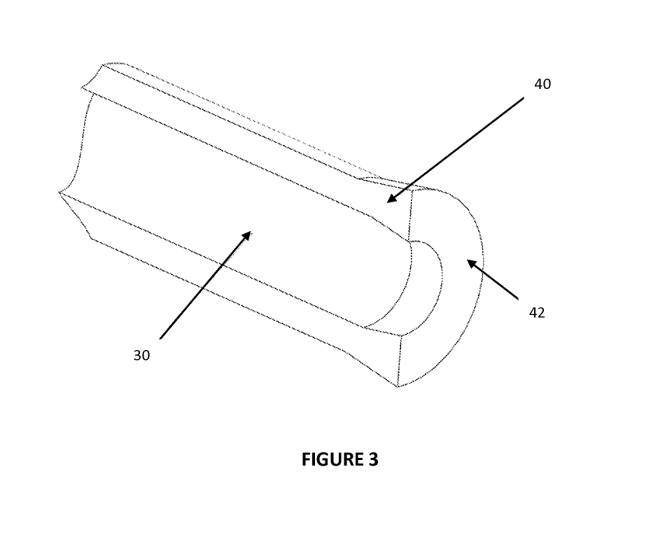

FIG. 3 shows a cross section of a pipe 30. The pipe 30 may be considered to be a curved surface within the definition of this document. The pipe 30 shows an example of how a pipe end 40 may be supplied for precision machine processing in order to meet desired dimensional specifications. The pipe end 40 may be formed, for example, by a swaging process, a hot upset process or any hot or cold forming process that may generate the desired pipe end.

The inside diameter of one or both of the pipes 30 to be joined may be machined such that the inside diameters are substantially concentric, having the same inside diameter within a specified tolerance. The face planes, mating surfaces or face profiles 42 of the pipe joint may be precision machine processed such that they are parallel or non-parallel and coincident (unless otherwise specified). The outside diameters of each pipe 30 may be machined such that the outside diameters are substantially concentric and having the same outside diameter within a specified tolerance. The pre-joining precision machine processing may include one or more pre-joining processes that include but are not limited to turning, milling, reaming, facing, etc. as known to those skilled in the art. Precision machine processing of the pipes 30 may occur immediately prior to friction stir joining.

Machining equipment is currently used to prepare pipe joints for conventional fusion welding using stationary machining equipment as well as portable machining equipment in the field. However, this machining equipment described above typically may only machine the face of each pipe by cutting a bevel on an outside corner of each pipe end.

In contrast, the first embodiment may use stationary precision machine processing equipment and portable precision machine processing equipment that may be operated in the field or at a work site, but with the capability of performing precision machine processing of the pipe ends 40.

More specifically, the machining equipment may be capable of modifying curved surfaces of the pipe ends 40. The curved surfaces include any part of the pipe ends 40, whether or not the surface being machines is actually curved or not. Thus, modifying the curved surfaces includes but is not limited to modifying a face profile 42 of each pipe end 40, modifying an ID, modifying an OD, modifying concentricity of the curved surfaces of the pipe ends, modifying coincidence of the face profile, modifying the face profile to include a non-linear feature, modifying the face profile to include at least one thread, at least one groove, at least one chamfer, at least one mating spline, at least one non-mating spline, and reaming.

The machining equipment may also be capable of forming a face profile that may be non-planar and coincident. Non-planar features of a path along the pipe joint 32 may include one or more of the following: a bias, an elliptical configuration and an arcuate configuration on the face profile.

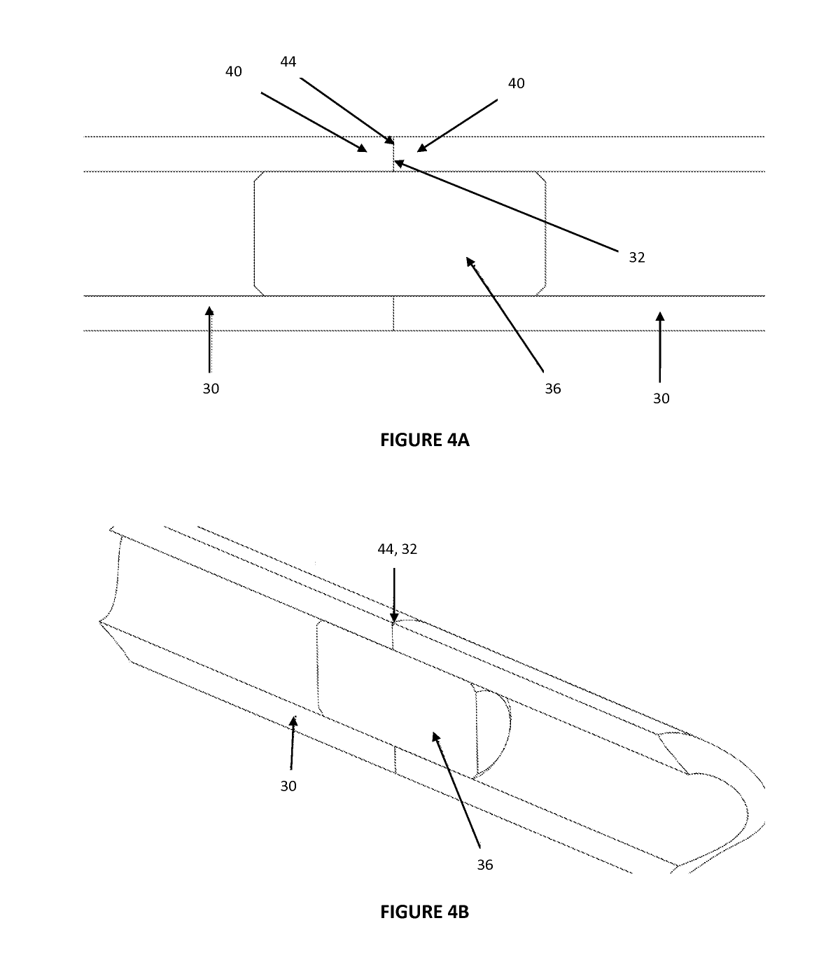

In addition, the machining equipment may be capable of machining specific geometries on the pipe end 40 at the face profile 42 in order to manage heat and material flow during the friction stir joining process. FIGS. 4A through 14B show various embodiments of geometries and configurations on the curved surfaces at the pipe ends 40 that are representative of, but should be considered as limited to, some of the modifications to the curved surfaces for enhancing friction stir joining capability and consistency.

FIGS. 4A and 4B are perspective cut-away views of pipe ends 40 prepared for friction stir joining including a standard butt joint 44 and a mandrel 36 underneath the pipe joint 32. In one or more embodiments, the mandrel 36 may expand or otherwise provide a force that counters the force of a friction stir joining tool that is pressing on the pipes 30 at the joint during friction stir joining processing.

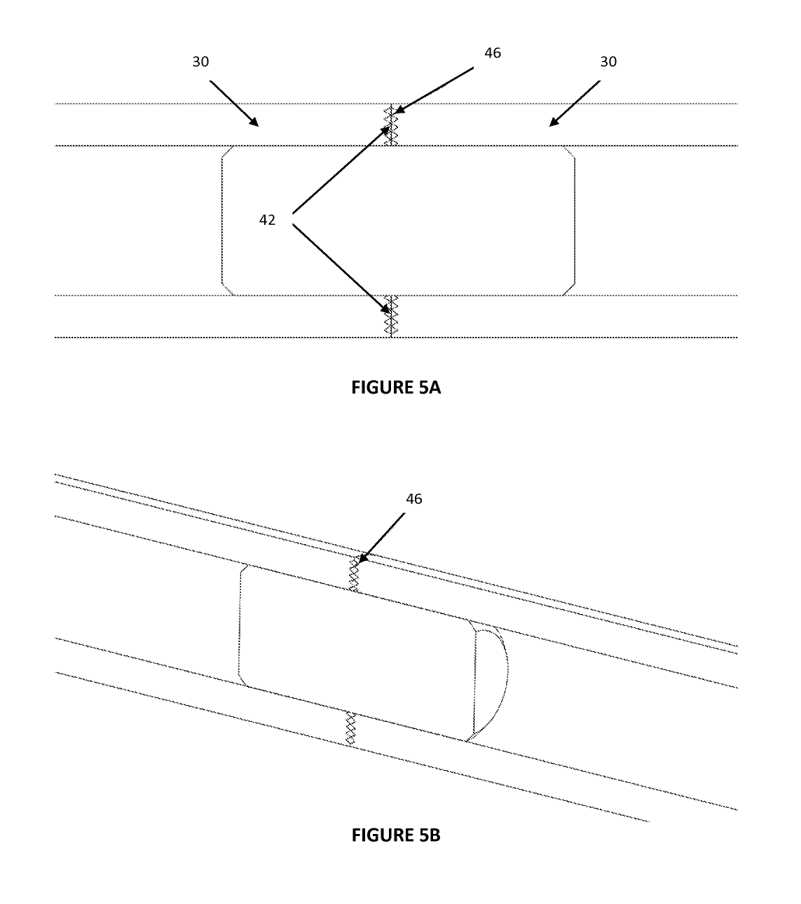

For FIGS. 5A through 15, the pipes 30, the pipe ends 40 and the mandrel 36 are the same, while the face profile 42 may be modified. Accordingly, only the changes to the face profile will be labeled and numbered.

FIGS. 5A and 5B show a perspective cut-away view of an embodiment of face profile 42, where the pipes 30 may be machined to provide a thread or groove profile 46. The thread or groove profile 46 may enable the pipes 30 to more precisely align and avoid any offset.

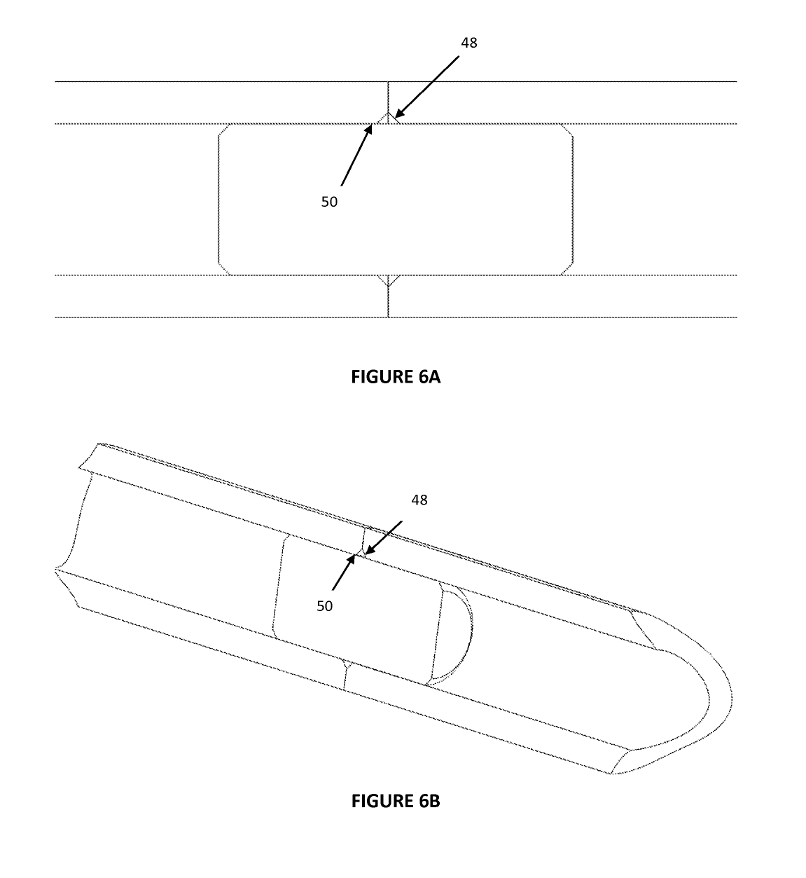

FIGS. 6A and 6B show a perspective cut-away view of another embodiment where the face profile 42 of the pipes 30 may be machined to include a chamfer 48, taper or bevel at the root 50 or ID.

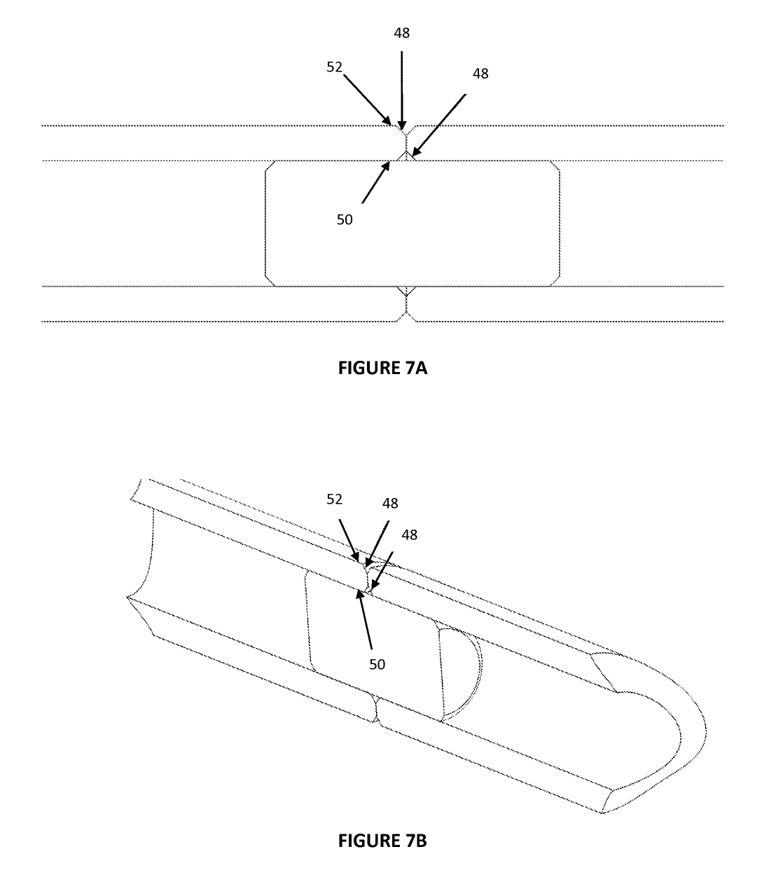

FIGS. 7A and 7B show a perspective cut-away view of another embodiment where the face profile 42 of the pipes 30 may be machined to include a chamfer 48, taper or bevel at the root 50 of the pipes and at the OD corner 52 of the pipes.

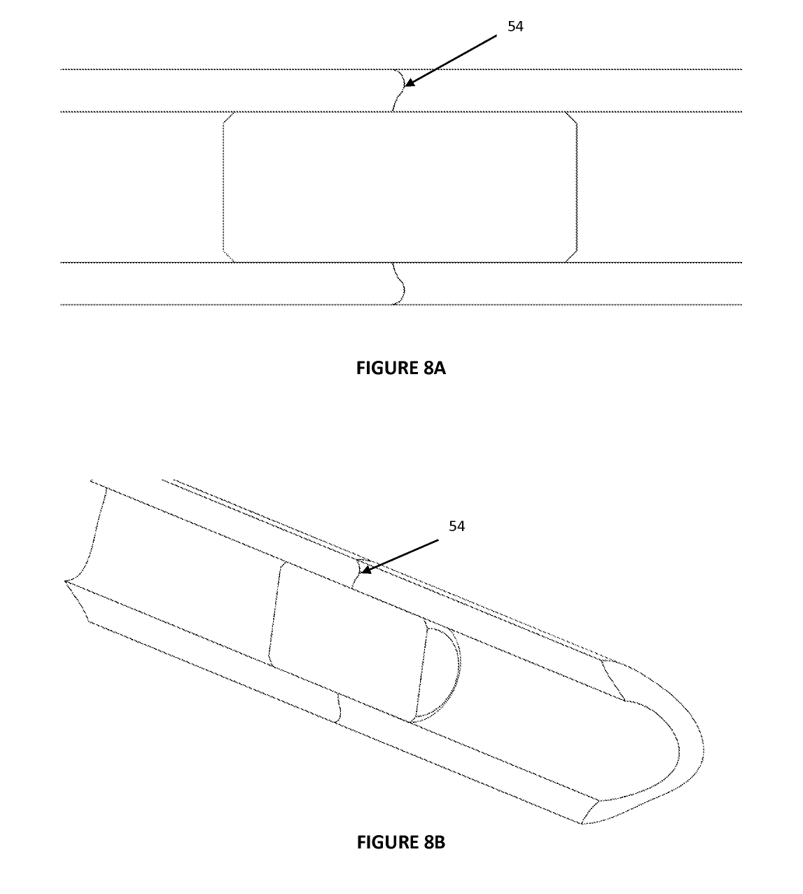

FIGS. 8A and 8B show a perspective cut-away view of another embodiment where the face profile 42 of the pipes 30 may be machined to have a curved profile 54. The curved profiles 54 of the two pipes 30 may be complementary, thereby enabling precise alignment of the pipes.

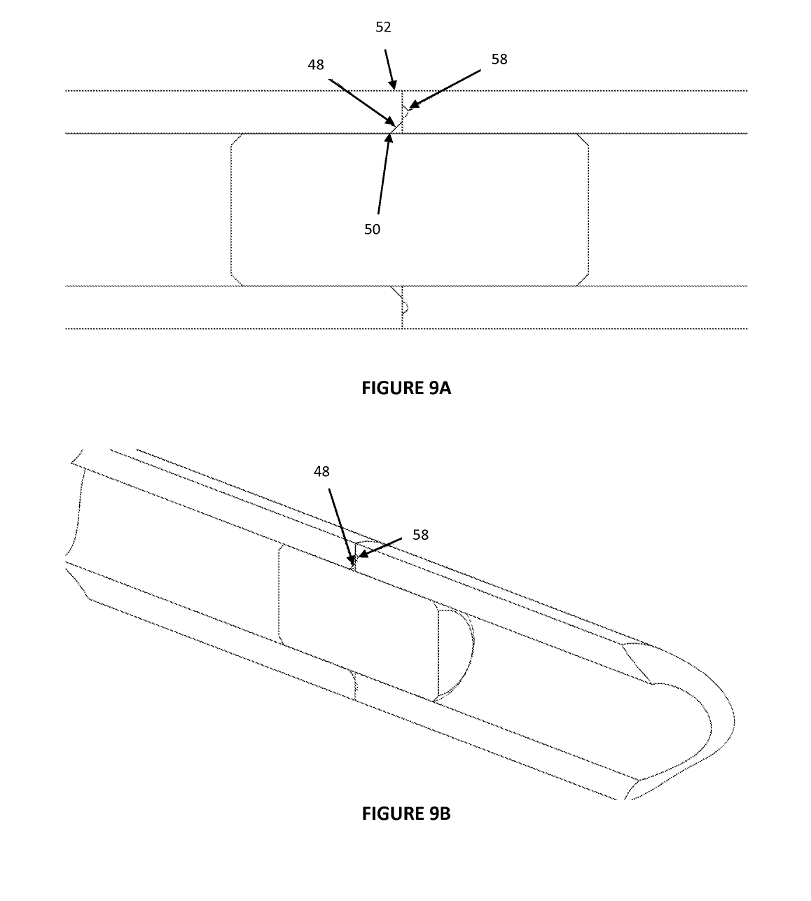

FIGS. 9A and 9B show a perspective cut-away view of another embodiment where the face profile 42 of the pipes 30 may be machined to have a profile that combines different profiles on each of the pipes. The face profiles 42 may not necessarily be complimentary to each other. For example, in this embodiment, a first face profile 42 includes a chamfer 48, bevel or taper at the root 50, while the second face profile 42 includes an end profile including a groove 58 that does not extend to the ID (root) 50 or OD corner 52. Grooves in this or other embodiments disclosed herein may be continuous or interrupted. Any combination of face profiles 42 may be provided on the profiles of the pipes 30, as long as the profiles do not prevent precise alignment of the pipes.

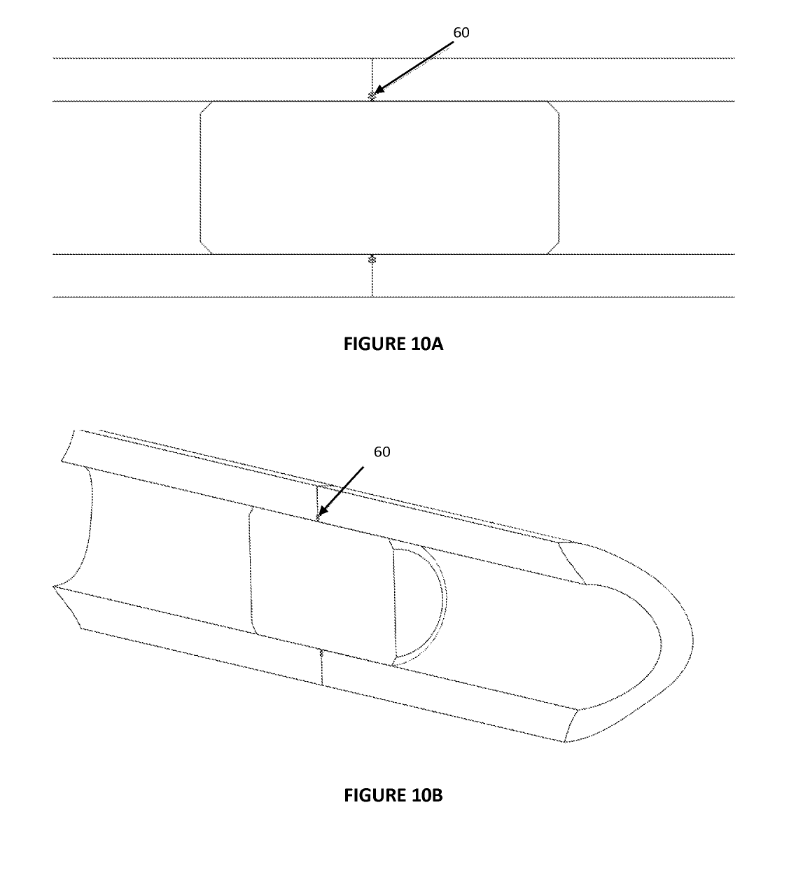

FIGS. 10A and 10B show a perspective cut-away view of another embodiment where the mating surface 42 of the pipes 30 may be machined to include a partial thread 60, groove or other profile, extending a selected distance from the root 50 of the pipes 30.

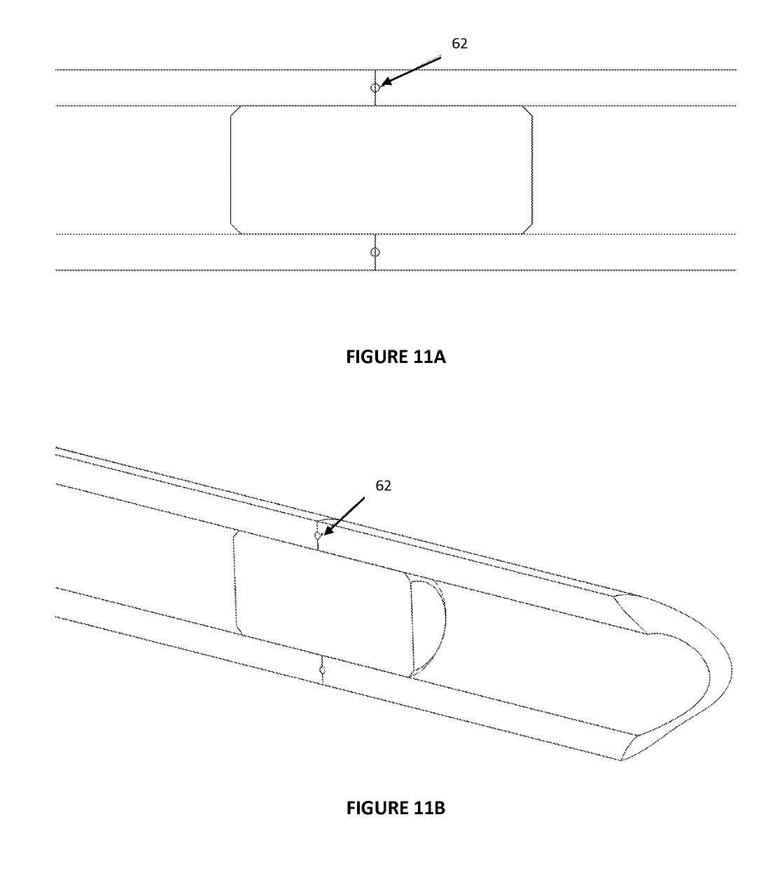

FIGS. 11A and 11B show a perspective view of another embodiment where the face profile 42 of the pipes 30 may be machined to include single profiles 62 (e.g., grooves) located interior of the ID (root) 50 and OD corner 52 and aligned with each other. In this and other embodiments, the face profile 42 may have multiple different profiles 62 which may or may not be aligned with each other, and which may or may not extend to the root 50 or the OD corner 52, and do not prevent pipe alignment.

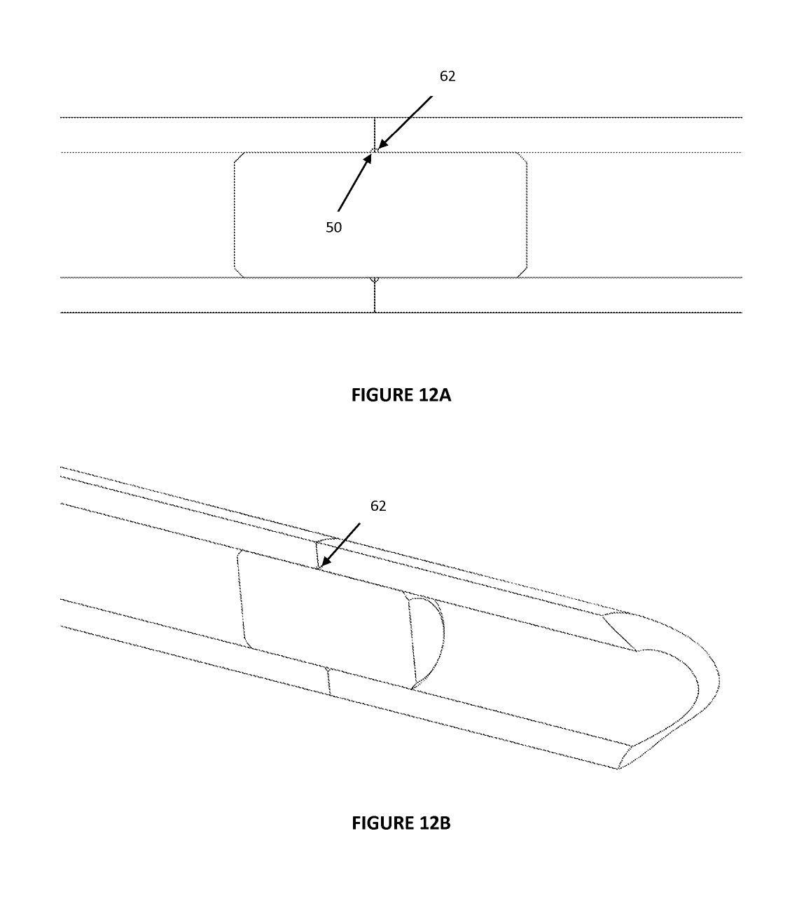

FIGS. 12A and 12B show a perspective view of another embodiment where the face profile 42 of the pipes 30 may be machined to include single profiles (e.g., grooves) 62 at the ID (root) 50.

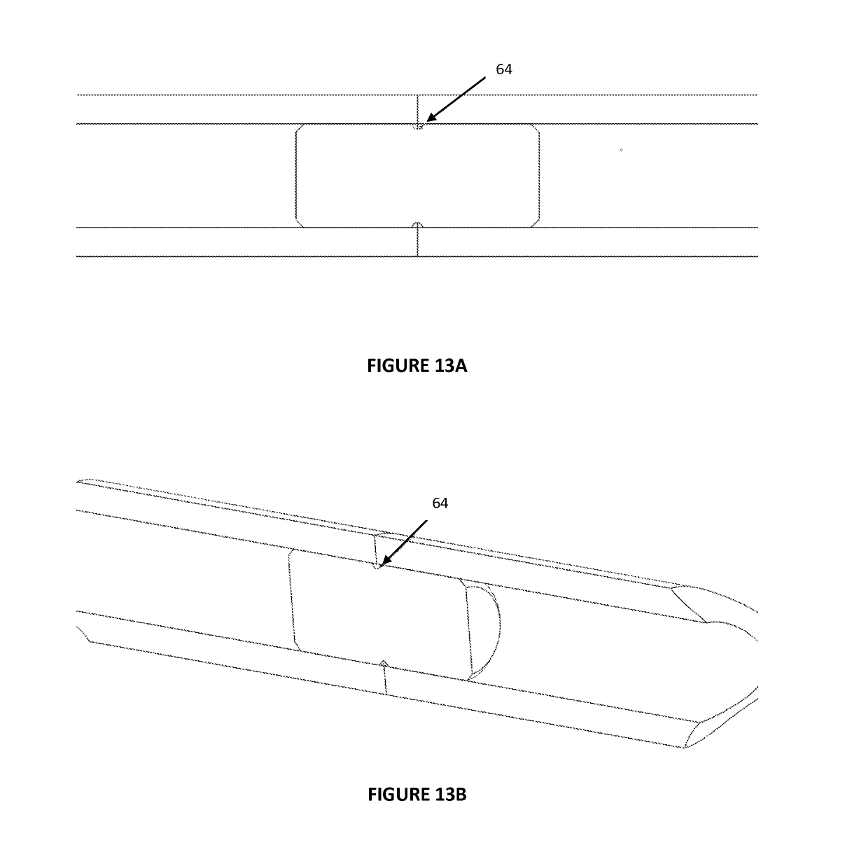

FIGS. 13A and 13B show a perspective view of another embodiment where the face profiles 42 of the pipes 30 do not include profiles, but the mandrel 36 may be machined to include a profile that may alter flow of the pipe material. For example, a dimple 64 is shown in the mandrel 36. In additional embodiments, one or both face profiles 42 of the pipes 30 may have a profile machined thereon.

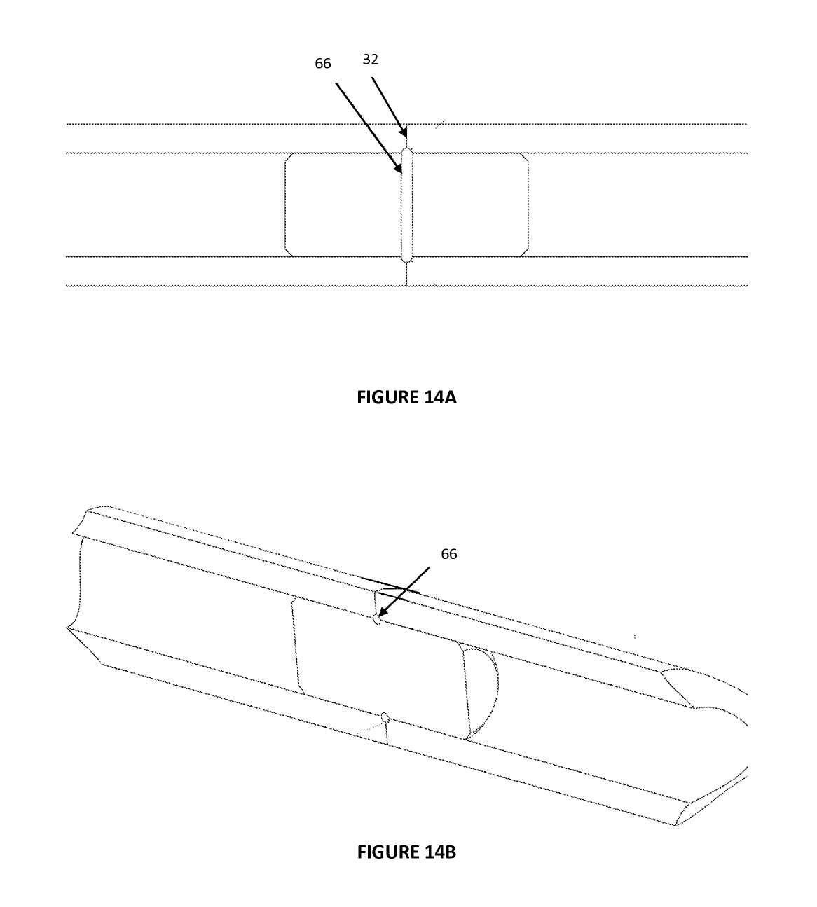

FIGS. 14A and 14B show a perspective cut-away view of another embodiment where the face profiles 42 and the mandrel 36 may be machined and configured to allow a filler material 66 to be joined to the pipes 30 during friction stir joining to thereby alter mechanical flow, and/or temperature and/or mechanical properties of the pipe joint 32. In this figure, the filler material may be disposed as a ring at the root 50 of the pipes 30. The filler material may be pushed farther up the pipe joint 32.

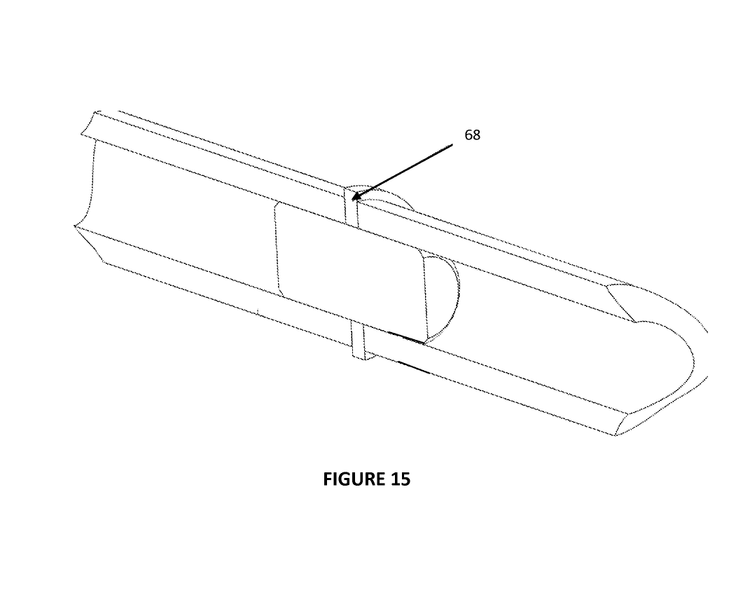

FIG. 15 is a perspective view of another embodiment that shows a filler material 68 disposed between the face profiles 42. The filler material 68 may have the same face profile 42 as those mentioned above for the pipe ends 40, or it may something different such as a fusion weld bead. The filler material 68 may have a larger OD than the pipe so that it functions as rough stock that can be removed or for strengthening the pipe joint 32.

The filler material 68 is not required but is an optional component that may be selected in some embodiments for enhancing corrosion resistance properties of the pipe joint 32, improving pipe joint strength, providing material for friction stir joining, standing proud of the two curved pipe surfaces, and/or enabling conventional welding or tacking of the pipe joint before friction stir joining.

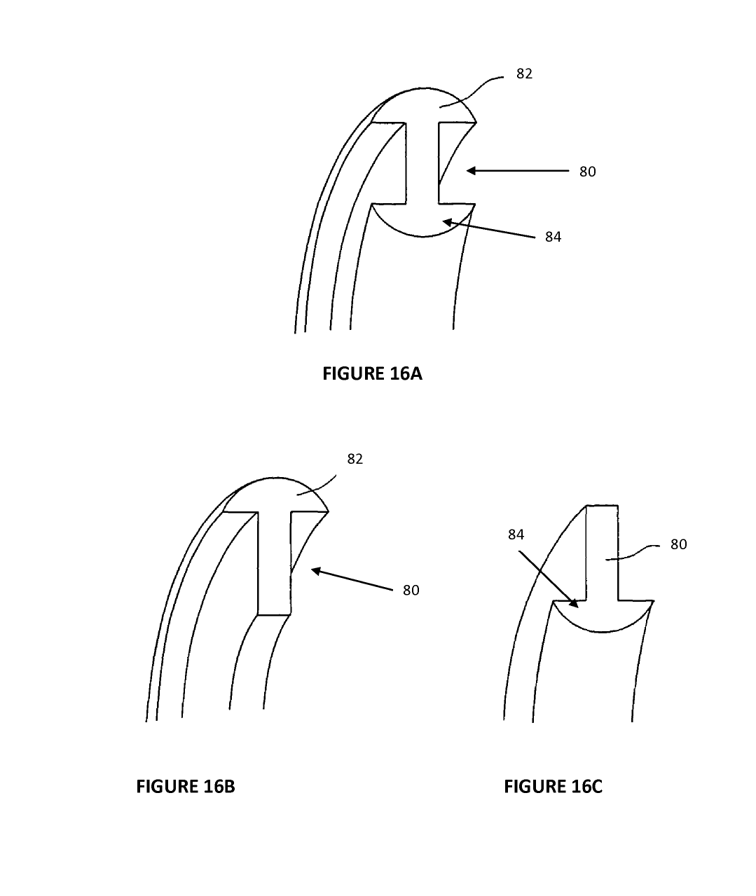

FIG. 16A is a perspective view of another embodiment that shows filler material 80 that may be disposed between the face profiles 42. The filler material 80 includes a rounded head 82 that may fit above the OD of the pipes 30 and a rounded head 84 that may fit below the ID of the pipes. The filler material 80 may have a larger OD than the pipe so that it functions as rough stock that can be removed or for strengthening the pipe joint 32. It should also be understood that the rounded head may be replaced by another shape. What is important is that additional material is found on the filler material 80 both above the OD of the pipes 30, and below the ID of the pipes.

FIG. 16B is an alternative embodiment of FIG. 16A, where the filler material 80 may only have the rounded head 82 above the OD of the pipes 30.

FIG. 16C is an alternative embodiment of FIG. 16A, where the filler material 80 may only have the rounded head 82 below the ID of the pipes 30.

Once the face profile 42 is complete on the pipe ends 40, any oxides present may be removed. Oxides may be removed from the end surface(s) of the pipes to be joined, as well as the surface of the mandrel 36 if a mandrel is being used, and any other surface that is exposed to and therefore may affect the friction stir joining process. In working environments where there is high humidity, careful attention should be paid to assure oxide does not reform on surfaces before initiating the friction stir joining process. If any oxide does reform, it may be removed just before joining. Oxide may be removed by mechanical abrasion such as sanding, grit blasting, etc. Oxide may also be removed by oxide reducing materials which include liquids and jells.

When a mandrel 36 is being used, the mandrel may be positioned to align the pipes 30 and position the pipe faces together for friction stir joining. Once positioned, the mandrel 36 may be expanded into position against the inside diameter of the pipes 30.

The friction stir joining process may be performed with or without a shielding gas. Possible shield gases that may be used include argon and other inert gases that inhibit corrosion or explosions. The friction stir joining process is well known to those skilled in the art. Tool geometries, offset tool position, traverse speed and other parameters may be set and maintained for desired mechanical properties of the joint.

Another aspect of this and other embodiments may be the use of a stationary shoulder and a rotating pin on a curved surface.

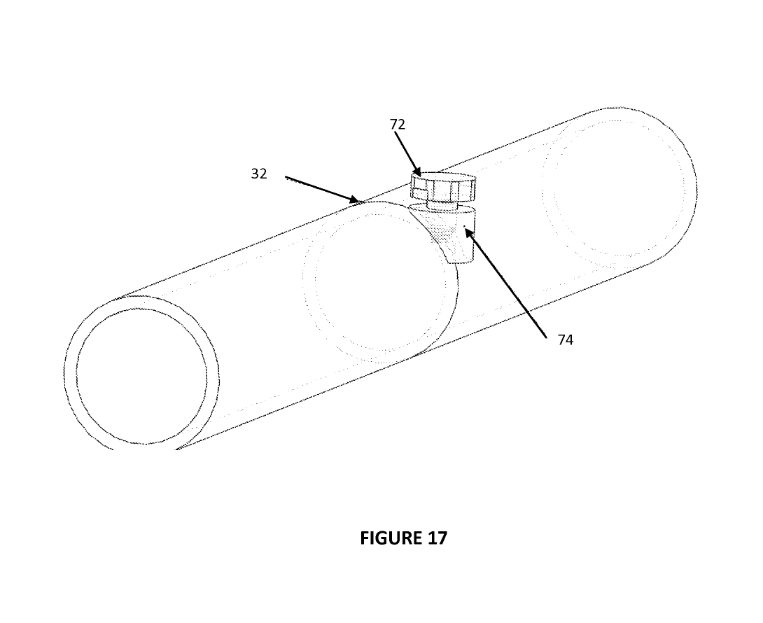

FIG. 17 is a perspective view of a stationary shoulder tool configuration. This configuration may or may not use a mandrel. The configuration shown in FIG. 16 allows for the pin of the friction stir joining tool to be retracted during friction stir joining to thereby avoid using a run-off tab.

The stationary shoulder friction stir joining tool 72 may be used in a manner such that it is not normal to the pipes 30. The stationary shoulder friction stir joining tool 72 may be operated such that it may rotate at greater than 10 revolutions per minute, it may have a Z-axis load on the pin that may be greater than 10 lbf, it may have a clearance between the pin and the stationary shoulder 74 that may be greater than 0.0001 inches, and it may provide a channel for the stationary shoulder around the pin for flash control.

Liquid cooling may be provided to the pin and/or the stationary shoulder 74, or cooling may be used that includes using a heat transfer material, radiative cooling, conductive cooling, and/or convective cooling.

The friction stir joining process may benefit from making the stationary shoulder friction stir joining tool 72 or the friction stir joining tool 34 traverse a path that is non-linear along the pipe joint 32. These non-linear paths include an arc path, a helical path, an elliptical path, a sinusoidal path and an oval path.

Post joining processes may be performed such as run-off tab removal, flash removal and/or post weld heat treatment in order to alter the mechanical properties of the pipe joint 32 after friction stir joining processing.

In another embodiment, a first pipe includes rough stock material, and a second pipe does not. However, both the first pipe and the second pipe may still be precision machine processed. For example, a face profile of the second pipe may be precision machine processed in order to have a face profile that is complimentary to the face profile of the first pipe.

Similarly, in another embodiment, neither the first pipe nor the second pipe includes rough stock material. However, both the first pipe and the second pipe may still be precision machine processed in order to have face profiles that are complementary.

There are many configurations of the embodiments described above that may be used independently or jointly to enhance the capability and consistency of the friction stir joining process.

Although a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for preparing curved surfaces for friction stir joining, said method comprising:
1) obtaining a first curved surface having a first end and a second curved surface having a first end, the first end of the first curved surface and the first end of the second curved surface including rough stock material;
2) precision machine processing a face profile into the first end of the first curved surface and the first end of the second curved surface, removing at least a portion of the rough stock material; and
3) aligning the first end of the first curved surface and the first end of the second curved surface together to form a joint.

2. The method as defined in claim 1 wherein the method further comprises positioning a mandrel under the joint.

3. The method as defined in claim 2 wherein the method further comprises performing friction stir joining on the joint between the first end of the first curved surface and the first end of the second curved surface using a friction stir joining tool.

4. The method as defined in claim 2 wherein the method further comprises performing friction stir joining on the joint between the first end of the first curved surface and the first end of the second curved surface using a stationary shoulder friction stir joining tool.

5. The method as defined in claim 1 wherein performing friction stir joining further comprises using a shielding gas at the joint to prevent corrosion during friction stir joining.

6. The method as defined in claim 1 wherein the method further comprises forming the rough stock material on the first curved surface and the second curved surface using a hot working process.

7. The method as defined in claim 1 wherein the method further comprises forming the rough stock material on the first curved surface and the second curved surface using a cold working process.

8. The method as defined in claim 1 wherein the method further comprises using precision machine processing equipment for machining the face profile into the first end of the first curved surface and the first end of the second curved surface.

9. The method as defined in claim 8 wherein the precision machine processing equipment is portable precision machine processing equipment.

10. The method as defined in claim 8 wherein the precision machine processing equipment is stationary precision machine processing equipment.

11. The method as defined in claim 1 wherein the method further comprises performing precision machine processing using at least one of the following processing steps: removing at least a portion of the rough stock material at the inner diameter, removing at least a portion of the rough stock material at the outer diameter, modifying concentricity, modifying the coincidence of the face profile, modifying the face profile to include a non-linear feature, modifying the face profile to include at least one thread, modifying the face profile to include at least one groove, modifying the face profile to include at least one chamfer, modifying the face profile to include at least one mating spline, modifying the face profile to include at least one non-mating spline, and reaming a face profile.

12. The method as defined in claim 11 wherein the method further comprises precision machine processing the face profile so that it is non-planar and coincident.

13. The method as defined in claim 12 wherein the method further comprises selecting the non-planar feature from the group of non-planar features including: a bias, an elliptical configuration and a curved configuration.

14. The method as defined in claim 1 wherein the method further comprises disposing a filler material between the face profile of the first end of the first curved surface and the first end of the second curved surface, wherein the filler material becomes part of the joint.

15. The method as defined in claim 14 wherein the method further comprises selecting the filler material based on at least one of the following characteristics: enhancing corrosion resistance properties of the joint, improving joint strength, providing material for friction stir joining, providing a surface standing proud of the first curved surface and the second curved surface, and enabling conventional welding or tacking of the joint before friction stir joining.

16. The method as defined in claim 1 wherein the method further comprises placing a fusion weld bead along the joint before friction stir joining.

17. The method as defined in claim 1 wherein the method further comprises removing oxides from the machined face profile to be joined.

18. The method as defined in claim 1 wherein the method further comprises providing a surface feature along the joint that enables material flow of the first end of the first curved surface and the first end of the second curved surface during friction stir joining.

19. The method as defined in claim 1 wherein the mandrel is an expandable mandrel.

20. The method as defined in claim 1 wherein the method further comprises performing friction stir joining using a stationary shoulder on a friction stir joining tool.

21. The method as defined in claim 20 wherein the method further comprises plunging the friction stir joining tool into the joint during rotation of the joint between the first curved surface and the second curved surface.

22. The method as defined in claim 20 wherein the method further comprises offsetting the friction stir joining tool so that it is not normal to the joint between the first curved surface and the second curved surface.

23. The method as defined in claim 20 wherein the method further comprises rotating a pin of the friction stir joining tool at greater than 10 revolutions per minute.

24. The method as defined in claim 21 wherein the method further comprises retracting the friction stir joining tool from the joint during rotation of the first curved surface and the second curved surface.

25. The method as defined in claim 24 wherein the method further comprises placing a Z-axis load on the pin that is greater than 10 lbf.

26. The method as defined in claim 24 wherein the method further comprises providing clearance between the pin and the stationary shoulder that is greater than 0.0001 inches.

27. The method as defined in claim 24 wherein the pin and the stationary shoulder are comprised of at least some different materials.

28. The method as defined in claim 24 wherein the method further comprises maintaining clearance of the stationary shoulder above the joint of at least 0.0001 inches.

29. The method as defined in claim 24 wherein the method further comprises providing a channel for the stationary shoulder around the pin for flash control.

30. The method as defined in claim 24 wherein the method further comprises providing liquid cooling for the stationary shoulder.

31. The method as defined in claim 24 wherein the method further comprises providing liquid cooling for the pin.

32. The method as defined in claim 24 wherein the method further comprises selecting a cooling process for the friction stir joining tool that is selected from the group of cooling processes consisting of: a heat transfer material, radiative cooling, conductive cooling, and convective cooling.

33. The method as defined in claim 1 wherein the method further comprises using a shape of the friction stir joining tool to force material flow of the first curved surface and the second curved surface.

34. The method as defined in claim 1 wherein the method further comprises using a shape of the friction stir joining pin to prevent root defect.

35. The method as defined in claim 1 wherein the method further comprises creating a joint having a finer grain size than a material used for the first curved surface and the second curved surface.

36. The method as defined in claim 4 wherein the method further comprises heat treating the joint to alter mechanical properties thereof.

37. The method as defined in claim 4 wherein the method further comprises using a temperature control algorithm to perform friction stir joining.

38. The method as defined in claim 1 wherein the method further comprises moving the friction stir joining tool in a non-linear path along the joint.

39. The method as defined in claim 38 wherein the non-linear path is selected from the group of non-linear paths consisting of: an arc path, a helical path, an elliptical path, and an oval path.

40. The method as defined in claim 14 wherein the method further comprises providing a head on the filler material on the OD of the pipes.

41. The method as defined in claim 40 wherein the method further comprises providing a head on the filler material on the ID of the pipes.

42. A method for performing friction stir joining on curved surfaces, said method comprising:
1) obtaining a first curved surface having a first end and a second curved surface having a first end, the first end of the first curved surface and the first end of the second curved surface including rough stock material;
2) precision machine processing a face profile into the first end of the first curved surface and the first end of the second curved surface, removing at least a portion of the rough stock material;
3) aligning the first end of the first curved surface and the first end of the second curved surface together to form a joint; and
4) friction stir joining the first end of the first curved surface and the first end of the second curved surface.

43. A method for preparing curved surfaces for friction stir joining, said method comprising:
1) obtaining a first curved surface having a first end and a second curved surface having a first end, the first end of the first curved surface including rough stock material;
2) precision machine processing a face profile into the first end of the first curved surface, removing at least a portion of the rough stock material;
3) precision machine processing a face profile into the first end of the second curved surface; and
4) aligning the first end of the first curved surface and the first end of the second curved surface together to form a joint.

44. A method for preparing curved surfaces for friction stir joining, said method comprising:
1) obtaining a first curved surface having a first end and a second curved surface having a first end, wherein nether the first end of the first curved surface or the first end of the second curved surface include rough stock material;
2) precision machine processing a face profile into the first end of the first curved surface;
3) precision machine processing a face profile into the first end of the second curved surface; and aligning the first end of the first curved surface and the first end of the second curved surface together to form a joint.
